(19) United States
(12) Patent Application Publication
(10) Pub. No.: US 2024/0180311 A1
(43) Pub. Date: Jun. 6, 2024

(54) HAIRCARE APPLIANCE

(71) Applicant: Dyson Technology Limited, Wiltshire (GB)

(72) Inventors: Kyle James CRAWFORD, Cirencester (GB); Benjamin James HOGAN, Malmesbury (GB); Michael Medrano RECINTO, Lipa City (PH); Al Salcedo PINEDA, Singapore (SG); Robert STREETER, Singapore (SG); James Evon DSOUZA, Singapore (SG); Craig DOUGLAS, Muntinlupa (PH)

(73) Assignee: Dyson Technology Limited, Wiltshire (GB)

(21) Appl. No.: 18/285,488

(22) PCT Filed: Mar. 28, 2022
(86) PCT No.: PCT/GB2022/050767

§ 371 Date: Oct. 3, 2023

(30) Foreign Application Priority Data
Apr. 8, 2021 (GB) 2104987.9

(51) Int. Cl. A45D 20/12

(52) U.S. Cl. CPC A45D 20/12

(57) ABSTRACT

A haircare appliance has an air inlet, an air outlet, an airflow generator for generating an airflow from the air inlet to the air outlet, and a heater assembly for heating the airflow. The heater assembly has a heater and a heater housing. The heater is mounted to the heater housing at a plurality of discrete mounting points.

### FIELD OF THE INVENTION

The present invention relates to a haircare appliance.

### BACKGROUND OF THE INVENTION

Haircare appliances are generally used to treat or style hair, and some haircare appliances may treat or style hair using heat. Some hair treatment or styling processes may require use of relatively high temperatures, which may pose a risk to a user of a haircare appliance.

### SUMMARY OF THE INVENTION

According to a first aspect of the present invention there is provided a haircare appliance comprising an air inlet, an air outlet, an airflow generator for generating an airflow from the air inlet to the air outlet, and a heater assembly for heating the airflow, the heater assembly comprising a heater and a heater housing, wherein the heater is mounted to the heater housing at a plurality of discrete mounting points.

The haircare appliance according to the first aspect of the present invention may be beneficial as the heater is mounted to the heater housing at a plurality of discrete mounting points. In particular, there may be a compromise to be reached between thermal transfer from the heater to the heater housing, and distribution of load impact from the heater to the heater housing in the event that the haircare appliance experiences an impact, for example as a result of the haircare appliance being dropped, in use. It may be desirable for there to be as little contact as possible between the heater and the heater housing to avoid thermal transfer of heat from the heater to the heater housing. A single point of contact between the heater and the heater housing may therefore be desirable from a thermal perspective. Equally, it may be desirable for there to be a large contact area between the heater and the heater housing to distribute forces that may occur when the haircare appliance experiences an impact in use. Continuous contact between the heater and the heater housing may therefore be desirable from a mechanical integrity perspective. The haircare appliance according to the first aspect of the present invention provides a comprise between these two competing factors as the heater is mounted to the heater housing at a plurality of discrete mounting points, which may provide limited thermal transfer whilst ensuring mechanical integrity in the event of impacts experienced in use.

The heater housing may comprise a material having a lower thermal conductivity than a material of the heater. Thus the heater housing may inhibit direct thermal transfer of heat from the heater to other components of the haircare appliance, for example an outer body of the haircare appliance, thereby ensuring user safety.

The haircare appliance may comprise a mounting member located at at least one of the plurality of discrete mounting points, and the mounting member may be resiliently deformable, for example resiliently deformable relative to the heater housing and/or the heater. Use of a resiliently deformable mounting member may account for tolerances in dimensions of the heater and/or the heater housing, and may reduce transmission of forces from the heater housing to the heater in the event that the haircare appliance experiences an impact force in use. This may be particularly beneficial where the heater is formed of a relatively brittle material, such as a ceramic.

The mounting member may comprise a discrete mounting member attached to the heater housing. Use of a discrete mounting member attached to the heater housing may provide greater flexibility compared to a mounting member integrally formed with the heater housing as a monolithic component, as, for example, different material choices may be made for the discrete mounting member relative to the heater housing.

The discrete mounting member may be attached to the heater housing such that relative movement is enabled between the discrete mounting member and the heater housing. The discrete mounting member may be spot welded to the heater housing. The discrete mounting member may act as a solid lubricant between the heater and the heater housing.

The mounting member may comprise a melting point greater than an operating point of heater, for example with the mounting member melting at a temperature greater than an operating temperature of the heater. The mounting member may comprise a melting point of at least 250° C., at least 300° C., at least 350° ° C., or at least 400° ° C. The heater may comprise an operating temperature in the region of 200° ° C., 250° C., 300° C., or 350° C.

The mounting member may comprise a first material, the heater housing may comprise a second material, and the first material may be relatively softer than the second material. This may inhibit the heater housing from damaging the heater at the mounting point that the mounting member is located in the event of an impact experienced by the haircare appliance in use, for example when the haircare appliance is dropped by a user in use.

The first material may comprise any of copper or nickel. Copper or nickel may provide a relatively soft material to interface with the heater. The second material may comprise stainless steel. Stainless steel may provide a relatively thermal insulating material, whilst also providing good strength and structural rigidity.

The mounting member may be integrally formed with the heater housing, for example such that the heater housing and the mounting member comprise a monolithic component. Integrally forming the heater housing and the mounting member may reduce component count and cost. The mounting member may be movable relative to a main portion of the heater housing, for example resiliently deformable relative to the main portion of the heater housing.

The mounting member may comprise a fixed mounting member that defines at least one of the plurality of discrete mounting points. A fixed mounting member may inhibit movement of the heater relative to the heater housing in use.

The fixed mounting member may inhibit motion of the heater in a first direction, and the resiliently deformable member may inhibit motion of the heater in a second direction different to the first direction. Thus the movement of the heater relative to the heater assembly may be inhibited in two directions in normal use. The first direction may be substantially orthogonal to the second direction.

The haircare appliance may comprise a plurality of mounting members, each mounting member located at a respective one of the plurality of discrete mounting points. The plurality of mounting members may comprise mounting members of different types, for example with a combination of discrete mounting members attached to the heater housing and mounting members integrally formed with the heater housing, and/or a combination of fixed and resiliently deformable mounting members. The haircare appliance may comprise first and second fixed mounting members located at opposing ends of the heater housing, and at least one resiliently deformable mounting member located between the first and second fixed mounting members.

The heater housing may comprise first and second portions attached to one another. Forming the heater housing of first and second portions attached to one another may allow the heater housing to account for tolerances in dimensions of the heater. For example, where the heater comprises a ceramic material, tolerances in manufacture may be as high as +0.5%. Typically, ceramic materials may be ground post-manufacture to obtain a component of the desired dimension, but such grinding may add time and cost to a manufacturing process. By forming the heater housing of first and second portions attached to one another, tolerances in manufacture may be accounted for, for example by providing features on the portions of the heater housing that absorb tolerances, which may reduce time and cost of a heater manufacturing process.

Furthermore, by forming the heater housing of first and second portions attached to one another, a wider variety of heater geometries can be accommodated. For example, a heater housing formed of first and second portions attached to one another may enable use of a curved heater, which would otherwise prove difficult to insert into a single piece curved heater housing.

The first and second portions may be welded to one another, for example laser welded to one another. This may be beneficial compared to, for example, attachment features such as clips and the like, as such clips may need to accommodate a wide range of tolerances, and hence may need to be relatively large. Laser welding of the first and second portions of the heater housing may thereby minimise a required size of the heater housing compared to, for example, first and second heater housing portions attached to one another by attachment features such as clips and the like.

The first and second portions may be attached to one another such that the first and second portions overlap. This overlap may allow for absorption of tolerances of the heater, for example with the degree of overlap able to be varied to accommodate different sizes of heater. The first portion may comprise a female portion, and the second portion may comprise a male portion, such that a part of the second portion sits inwardly of a part of the first portion in the assembled heater housing.

The mounting member may be located on the second portion, for example the male portion, such that the mounting member is located on an inwardly facing surface of the assembled heater housing.

The heater and the heater housing may be curved in form, for example curved along their length such that the heater and the heater housing are generally arcuate in form. Such a curved heater and heater housing may enable an overall shape of the haircare appliance to be curved, which may provide an ergonomic haircare appliance that is easy for a user to hold and use. The heater and the heater housing may curve through at least 75°.

The haircare appliance may comprise an outer body defining a flow path between the air inlet and the air outlet, and the outer body may be curved in form. A curvature of the heater and heater housing may correspond substantially to a curvature of the outer body.

The heater assembly and the airflow generator may be disposed in the outer body, for example with the heater assembly located downstream of the airflow generator.

The heater may comprise a main body, and a plurality of fins extending outwardly from the main body, and the main body may be mounted to the heater housing at the plurality of discrete mounting points. Providing a plurality of fins extending outwardly may distribute heat outwardly from the main body, for example outwardly from a central region of the flow path to a periphery of the flow path, and may provide a relatively even heat distribution across a width of the flow path. By mounting the main body to the heater housing at the plurality of discrete mounting points, the need for the fins to provide structural integrity to the heater assembly may be reduced, which may enable the fins to extend across a greater extent of the flow path for a same volume of material than if the fins were required to be thicker to provide structural integrity.

The fins may comprise a different material to the main body, for example with the fins comprising copper and the main body comprising a ceramic material.

The heater may comprise a ceramic material. For example, the main body of the heater may comprise a ceramic material. The main body of the heater may comprise a conductive track. The main body of the heater may be curved in form, for example curved along its length. A central longitudinal axis of the main body may be substantially co-axial with a central longitudinal axis of the flow path defined by the outer body of the haircare appliance. The plurality of fins may extend substantially orthogonally from the main body, for example substantially orthogonally from either side of the main body.

The heater housing may comprise a first open end in fluid communication with the air inlet, and a second open end in fluid communication with the air outlet, and the haircare appliance may comprise a flow guide for guiding airflow exiting the second open end. Where the heater has a main body comprising a conductive track, and fins that extend outwardly from the main body, a temperature distribution of airflow exiting the heater assembly may be uneven, as the main body may generally be hotter than the fins.

Furthermore, where the flow path between the air inlet and the air outlet, and the heater assembly, are curved, there may be portions of airflow through the flow path that are higher velocity, and hence colder, than other portions of airflow through the flow path. By providing a flow guide for guiding airflow exiting the second open end of the heater housing, mixing of hot and cold airflow exiting the heater housing may occur, which may provide a more even temperature distribution across the air outlet of the haircare appliance.

The flow guide may be shaped to direct airflow exiting a central region of the second open end in a direction away from the central region. This may enable hotter airflow located at a centre of the flow path to be spread toward a periphery of the flow path, thereby providing a more even temperature distribution across the air outlet of the haircare appliance. This may be beneficial where the main body of the heater is located substantially centrally within the heater housing.

The flow guide may comprise a rib extending across the second open end of the heater housing, and a pair of wings extending forwardly from, and obliquely relative to, the rib. Thus the wings may act to push airflow outwardly from the rib in a direction downstream of the rib. The rib may extend substantially centrally across the second open end of the housing. The rib may overlie the main body of the heater. The rib may be in direct thermal contact with the heater. The wings may have a length shorter than a length of the rib, for example such that the wings extend only partially across the second open end of the heater housing. This may enable other components, for example an ioniser or the like, to also extend across the second open end of the heater housing. Each wing may be tapered in form, for example increasing in width in a direction toward an end of the rib.

The flow guide may be shaped to inhibit airflow exiting a peripheral region of the second open end. Airflow at a peripheral region of the second open end of the heater housing may be faster and/or colder than airflow at the central region of the second open end of the heater housing, and by inhibiting airflow exiting the peripheral region a relatively even temperature distribution may be achieved at the air outlet of the haircare appliance.

This may be particularly beneficial where the flow path between the air inlet and the air outlet, and the heater assembly, are curved, as it has been found that airflow along the inside of the bend may be faster and cooler than other airflow in the flow path. By inhibiting airflow exiting a corresponding peripheral region of the second open end of the heater housing, the impact of the fast and cold airflow may be mitigated, and a relatively even temperature distribution may be achieved at the air outlet of the haircare appliance. The baffle may cause mixing of airflow from the peripheral region of the second open end of the heater housing with airflow from the central region of the second open end of the heater housing.

The flow guide may comprise a baffle extending outwardly from the rib, for example extending outwardly from a first end of the rib. The baffle may extend substantially orthogonally relative to the rib. The baffle and the pair of wings may be located at opposing ends of the rib. This may allow for both spreading of heat from the central region of the heater housing and inhibiting cold airflow from passing through the peripheral region of the heater housing

According to a second aspect of the present invention there is provided a heater assembly for heating airflow through a haircare appliance, the heater assembly comprising a heater and a heater housing, wherein the heater is mounted in the heater housing at a plurality of discrete mounting points.

According to a third aspect of the present invention there is provided a haircare appliance comprising an air inlet, an air outlet, an airflow generator for generating an airflow from the air inlet to the air outlet, a heater assembly for heating the airflow, the heater assembly comprising a heater and a heater housing, the heater housing comprising a first open end in fluid communication with the air inlet and a second open in fluid communication with the air outlet, wherein the heater housing comprises a flow guide for guiding airflow exiting the second open end of the heater housing.

The haircare appliance according to the third aspect of the present invention may be advantageous as the heater housing comprises a flow guide for guiding airflow exiting the second open end of the heater housing. In particular, temperature distribution across the heater housing may not necessarily be even in practice, and by providing a flow guide for guiding airflow exiting the second open end of the housing a relatively even temperature distribution may be obtained at the air outlet by guiding the airflow leaving the heater housing, thereby causing mixing of different regions of airflow from the heater housing.

The flow guide may be shaped to direct airflow exiting a central region of the second open end in a direction away from the central region. This may enable hotter airflow located at a centre of a flow path through the heater housing to be spread toward a periphery of the flow path, thereby providing a more even temperature distribution across the air outlet of the haircare appliance. This may be beneficial where a main body of the heater is located substantially centrally within the heater housing.

The flow guide may comprise a rib extending across the second open end of the heater housing, and a pair of wings extending forwardly from, and obliquely relative to, the rib. Thus the wings may act to push airflow outwardly from the rib in a direction downstream of the rib. The rib may extend substantially centrally across the second open end of the housing. The rib may overlie the main body of the heater. The rib may be in direct thermal contact with the heater. The wings may have a length shorter than a length of the rib, for example such that the wings extend only partially across the second open end of the heater housing. This may enable other components, for example an ioniser or the like, to also extend across the second open end of the heater housing. Each wing may be tapered in form, for example increasing in width in a direction toward an end of the rib.

The flow guide may be shaped to inhibit airflow exiting a peripheral region of the second open end. Airflow at a peripheral region of the second open end of the heater housing may be faster and/or colder than airflow at the central region of the second open end of the heater housing, and by inhibiting airflow exiting the peripheral region a relatively even temperature distribution may be achieved at the air outlet of the haircare appliance. This may be particularly beneficial where the flow path between the air inlet and the air outlet, and the heater assembly, are curved, as it has been found that airflow along the inside of the bend may be faster and cooler than other airflow in the flow path. By inhibiting airflow exiting a corresponding peripheral region of the second open end of the heater housing, the impact of the fast and cold airflow may be mitigated, and a relatively even temperature distribution may be achieved at the air outlet of the haircare appliance. The baffle may cause mixing of airflow from the peripheral region of the second open end of the heater housing with airflow from the central region of the second open end of the heater housing.

The flow guide may comprise a baffle extending outwardly from the rib, for example extending outwardly from a first end of the rib. The baffle may extend substantially orthogonally relative to the rib. The baffle and the pair of wings may be located at opposing ends of the rib. This may allow for both spreading of heat from the central region of the heater housing and inhibiting cold airflow from passing through the peripheral region of the heater housing.

Optional features of aspects of the present invention may be equally applied to other aspects of the present invention, where appropriate.

### BRIEF DESCRIPTION OF THE DRAWINGS

FIG. 1 is a schematic view of a haircare appliance according to the present invention;

FIG. 2 is a view of a heater of the haircare appliance of FIG. 1;

FIG. 3 is a view of a heater assembly incorporating the heater of FIG. 2;

FIG. 4 is a view of a first portion of a heater housing of the heater assembly of FIG. 3;

FIG. 5 is a view of a second portion of the heater housing of the heater assembly of FIG. 3;

FIG. 6 is a schematic view of a copper pad utilised with the heater assembly according to the present invention;

FIG. 7 is an enlarged view of a front end of the heater assembly of FIG. 3, illustrating a flow guide according to the present invention;

FIG. 8a is a view of a reinforcing rib for the heater coupon;

FIG. 8b is a view of the reinforcing rib of FIG. 8a attached to the heater; and

FIG. 8c is a view of the reinforcing rib of FIG. 8a in situ within the heater housing; and

FIG. 9 is a view of and alternative version of a second portion of the heater housing.

### DETAILED DESCRIPTION OF THE INVENTION

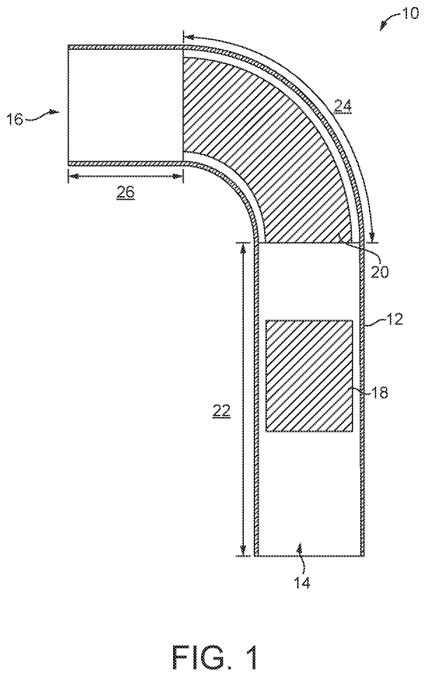

A haircare appliance, generally designated 10, according to the present invention is illustrated schematically in FIG. 1. The haircare appliance 10 comprises an outer body 12, an air inlet 14, an air outlet 16, an airflow generator 18, and a heater assembly 20.

The outer body 12 comprises a handle portion 22, a curved portion 24, and an outlet portion 26. The handle portion 22 is generally straight and cylindrical in form, and is intended to be grasped by a user in use. The air inlet 14 is located at an end of the handle portion 22, and in practice, although not illustrated here, the air inlet 14 may comprise a plurality of apertures formed in the handle portion 22. The handle portion 22 houses the airflow generator 18.

The curved portion 24 extends between the handle portion 22 and the outlet portion 26, and turns airflow through around 90° from the handle portion 22 to the outlet portion 26, such that airflow exits the air outlet 16 in a direction substantially orthogonal to the direction in which airflow flows through the handle portion 22. The curved portion 24 houses the heater assembly 20.

The outlet portion 26 is generally straight, cylindrical and hollow in form. The air outlet 16 is a generally circular aperture formed at the end of the outlet portion 26.

The airflow generator 18 generates an airflow from the air inlet 14 to the air outlet 16, through the handle portion 22, the curved portion 24 and the outlet portion 26, in use. The airflow generator 18 typically comprises a motor-driven impeller. An appropriate airflow generator is the Dyson V9 Digital Motor, produced by Dyson Technology Limited.

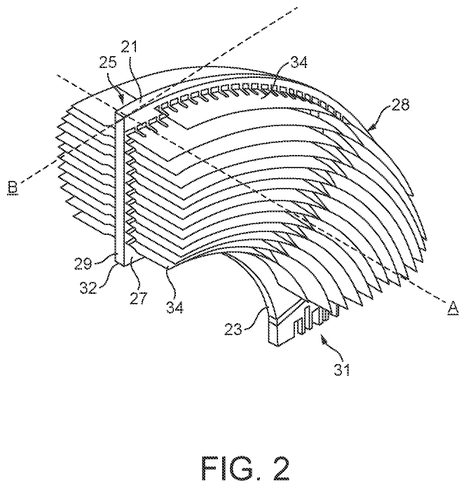

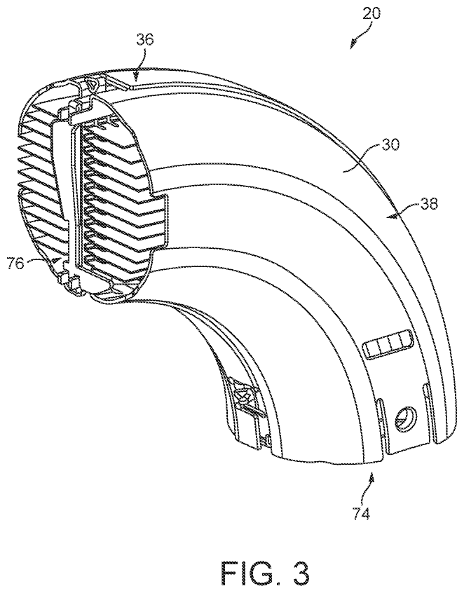

The heater assembly 20 comprises a heater 28 and a heater housing 30, with the heater 28 illustrated in FIG. 2, and the heater housing 30 illustrated in FIGS. 3 to 5.

The heater 28 comprises a main body 32 and a plurality of fins 34 extending outwardly from the main body. The main body 32 comprises a flat ceramic plate that is curved along its length, with a conductive trace printed onto the flat ceramic plate. The conductive trace can be surface mounted or encapsulated, as appropriate. The main body 32 thus defines a heater element of the heater 28. The main body 32 in some examples is formed of aluminium nitride. The main body 32 has top 21, bottom 23, right 25, left 27, front 29, and back 31 surfaces.

The plurality of fins 34 extend outwardly from the main body 32, substantially orthogonally to flat side surfaces of the main body 32. The plurality of fins 34 are formed of copper, and act to distribute heat outwardly from the main body 32.

The heater housing 30 comprises first 36 and second 38 portions, which may be referred to as right- and left-hand portions respectively. Although terms such as left, right, top and bottom may be used herein, it will be appreciated that these terms are used with respect to the images shown, and that the orientation of any of the components may vary in use.

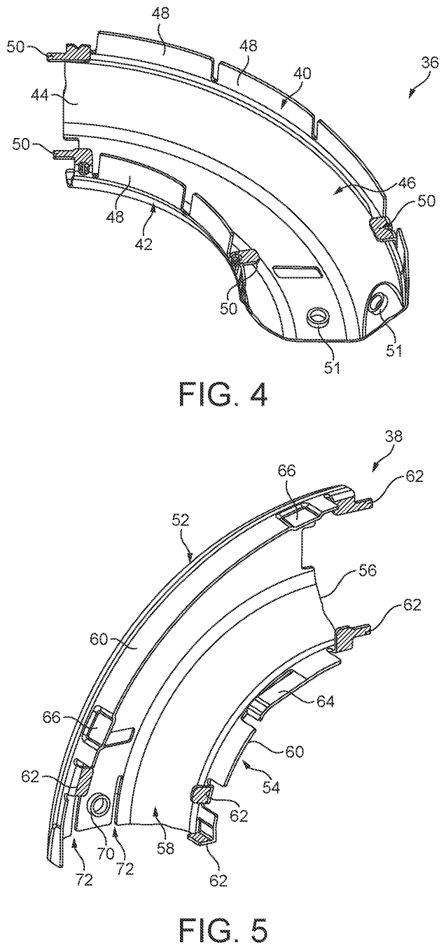

The first portion 36 of the heater housing 30 is a single-piece stainless steel structure, having top 40, bottom 42 and side 44 regions that collectively define a channel 46, as illustrated in FIG. 4. The side region 44 is illustrated in FIG. 4 as comprising two flat surfaces, but it will be appreciated that a single curved surface may be an appropriate alternative arrangement. The top 40 and bottom 42 regions of the first portion 36 of the heater housing 30 define mating surfaces 48 for mating with corresponding mating surfaces 60 of the second portion 38 of the heater housing 30. The top 40 and bottom 42 regions of the first portion 36 of the heater housing 30 further comprise discrete mounting points 50 which contact the main body 32 of the heater 28 as will be described hereinafter, with the discrete mounting points 50 illustrated with hashed shading in FIG. 4. The discrete mounting points 50 are folded relative to the remainder of the top 40 and bottom 42 regions of the first portion 36 of the heater housing 30. The discrete mounting points 50 have generally flat surfaces that correspond to the flat right surface 25 of the main body 32 of the heater 28.

The side region 44 of the first portion 36 of the heater housing 30 has two screw holes 51 which enable the heater housing 30 to be secured to the curved portion 24 of the outer body 12.

The first portion 36 of the heater housing 30 may be thought of as a female portion of the heater housing 30 as will be described hereafter.

The second portion 38 of the heater housing 30 is a single-piece stainless steel structure, having top 52, bottom 54 and side 56 regions that collectively define a channel 58, as illustrated in FIG. 5. The side region 56 is illustrated in FIG. 5 as comprising two flat surfaces, but it will be appreciated that a single curved surface may be an appropriate alternative arrangement. The top 52 and bottom 54 regions of the second portion 38 of the heater housing 30 define mating surfaces 60 for mating with corresponding mating surfaces 48 of the first portion 36 of the heater housing 30. The top 52 and bottom 54 regions of the second portion 38 of the heater housing 30 further comprise discrete mounting points 62 which contact the main body 32 of the heater 28 as will be described hereinafter, with the discrete mounting points 62 illustrated with hashed shading in FIG. 5. The discrete mounting points 62 are folded relative to the remainder of the top 52 and bottom 54 regions of the second portion 38 of the heater housing 30. The discrete mounting points 62 have generally flat surfaces that correspond to the flat left surface 27, or the flat back surface 31, of the main body 32 of the heater 28.

The bottom region 54 of the second portion 38 of the heater housing 30 further comprises a resilient mounting member 64. The resilient mounting member 64 is integrally formed with the remainder of the second portion 38 of the heater housing 30, and is formed by bending a portion of the bottom region 54 of the heater upwardly into the interior of the channel 58. The resilient mounting member 64 is shaped to engage the bottom surface 23 of the main body 32 of the heater 28.

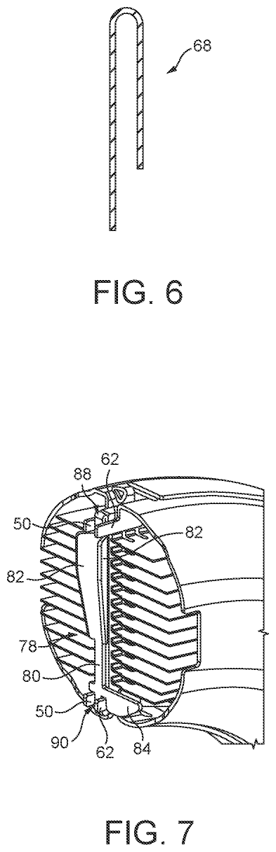

The top region 52 of the second portion 38 of the heater housing 30 comprises two depressions 66. Each depression 66 receives a copper pad 68, with the copper pads not shown in FIG. 5, but illustrated in isolation in FIG. 6. Each copper pad 68 is generally U-shaped in form, such that the copper pads 68 wrap around the top region 52 of the second portion 38 of the heater housing 30, and are located on top of and underneath the top region 52 of the second portion 38 of the heater housing 30. The copper pads 68 are spot-welded to the depressions 66, such that the copper pads 68 are movable relative to the first second portion 38 of the heater housing 30. The copper pads 68 have a melting point greater than an operating temperature of the heater 28, which is typically around 300° C. The copper pads 68 are shaped to engage the top surface 21 of the main body 32 of the heater 28.

The side region 56 of the second portion 38 of the heater housing 30 has a screw hole 70 which enables the heater housing 30 to be secured to the curved portion 24 of the outer body 12. A portion of the side region 56 in which the screw hole 70 is resiliently deformable relative to the remainder of the side region by virtue of slots 72, which may allow for tolerances to be accounted for when securing the heater housing 30 to the outer body 12.

The second portion 38 of the heater housing 30 may be thought of as a male portion of the heater housing 30 as will be described hereafter.

To assemble the heater assembly 20, the first 36 and second 38 portions of the heater housing 30 are slid together to encapsulate the heater 28. The top region 52 of the second portion 38 of the heater housing 30 underlies the top region 40 of the first portion 36 of the heater housing 30, and the bottom region 54 of the second portion 38 of the heater housing 30 underlies the bottom region 42 of the first portion 36 of the heater housing 30, such that the first 36 and second 38 portions of the heater housing 30 overlap one another. The degree of overlap can be varied before fixing the first 36 and second 38 portions of the heater housing together, which may enable tolerances in a thickness of the main body 32 of the heater 28 to be accounted for. The copper pads 68 provide at least a portion of an interface between the top region 52 of the second portion 38 of the heater housing 30 and the top region 40 of the first portion 36 of the heater housing 30.

Furthermore, the first 36 and second 38 portions of the heater housing 30 are slid together such that the discrete mounting points 50 of the first portion 36 of the heater housing 30 contact the flat right surface 25 of the main body 32 of the heater 28, and the discrete mounting points 62 of the second portion 38 of the heater housing 30 contact either the flat left surface 27 or the flat back surface 31 of the main body 32 of the heater 28 depending on the discrete mounting point 62 in question. The resilient mounting member 64 of the second portion 38 of the heater housing 30 engages the bottom surface 23 of the main body 32 of the heater 28, whilst the copper pads 68 engage the top surface 21 of the main body 32 of the heater 28. The resilient mounting member 64 and the copper pads 68 enable the heater housing 30 to account for tolerances in the height of the main body 32 of the heater 28, whilst the copper pads 68 also provide a relatively soft interface between the heater housing 30 and the main body 32 of the heater 28 compared to an interface provided by stainless steel.

Once the first 36 and second 38 portions of the heater housing 30 are in position relative to the heater 28, the first 36 and second 38 portions of the heater housing are laser welded together. Laser welding may be beneficial over mechanical connections such as clips or the like, as such clips may be required to be relatively large to accommodate for tolerances in dimensions of the heater 28.

In such a manner, the heater 28 is mounted to the heater housing 30 at a plurality of discrete mounting points, with the discrete mounting points defined by the discrete mounting points 50 of the first portion 36 of the heater housing 30, the discrete mounting points 62 of the second portion 38 of the heater housing 30, the resilient mounting member 64, and the copper pads 68. This may provide a good compromise between thermal transfer from the heater 28 to the heater housing, and force spreading in the event that the haircare appliance 10 is dropped in use. The heater 28 is inhibited from moving within the heater housing 30 in at least two directions by virtue of the mounting discussed above, with the two directions being along axes A and B illustrated in FIG. 2.

As the main body 32 of the heater 28 is formed of a ceramic material, a size of the main body 32 during manufacture may vary with a tolerance in the region of ±0.5%. The overlapping nature of the first 36 and second 38 portions of the heater housing 30 may account for tolerances in a width of the main body 32 of the heater 28, whilst the resilient mounting member 64 and the copper pads 68 may account for tolerances in a height of the main body 32 of the heater 28. It will be appreciated that in some embodiments copper pads 68 may be omitted and replaced by further resilient members, or vice versa.

As an alternative to the depressions 66 of the first portion 36 of the heater housing as shown in FIG. 5, a pair of compliant springs or further resilient mounting members 166 may be used. Referring now to FIG. 9, two further resilient mounting members 166 which are only connected to the first portion 36 of the heater housing at one end to provide additional flexibility. The further resilient mounting members 166 are provided in the top region 52 of the second portion 38 of the heater housing 30.

Copper pads (not shown) may be added to the further resilient mounting members 166 to provide a relatively soft interface between the heater housing 30 and the main body 32 of the heater 28 or they can be omitted.

As will be appreciated from FIGS. 3 to 5, the heater housing has a first open end 74 in fluid communication with the air inlet 14 of the haircare appliance 10, and a second open end 76 in fluid communication with the air outlet 16 of the haircare appliance 10, such that the heater housing 30 defines part of the flow path between the air inlet 14 and the air outlet 16.

It has been found that, in spite of the use of fins 34, airflow exiting the heater housing 30, ie exiting the second open end 76 of the heater housing 30, may be hotter in a central region than in a peripheral region, which may lead to an uneven temperature distribution at the air outlet 16. Furthermore, it has been found that, due to the curvature of the outer body 12, the heater 28 and the heater housing 32, along with swirl downstream of the airflow generator 18, a relatively fast and cold airflow may be experienced in a peripheral region of the heater housing 30, ie a peripheral region of the second open end 76 of the heater housing 30, on the inner edge of the curve of the heater housing 30.

To mitigate for these effects, the heater housing 30 comprises a flow guide 78 located at the second open end 76 of the heater housing 30. The flow guide 78 is schematically illustrated in position in FIG. 7.

The flow guide 78 comprises a rib 80, a pair of wings 82, and a baffle 84.

The rib 80 is elongate in form and has a length corresponding to a diameter of the second open end 76 of the heater housing 30. The rib 80 overlies the main body 32 of the heater 28, and is attached to frontwardly extending ones of the discrete mounting points 50 of the first portion 36 of the heater housing 30 and the discrete mounting points 62 of the second portion 38 of the heater housing 30.

Each wing 82 extends outwardly from, and forwardly from, the rib 80. The wings 82 are shaped to direct airflow from a central region of the second open end 76 of the heater housing 30 to peripheral regions of the second open end 76 of the heater housing 30. Thus hotter airflow from a central region of the heater housing 30, ie airflow adjacent to the main body 32 of the heater 28, may be mixed with cooler airflow at peripheral regions of the heater housing 30, thereby providing a relatively even temperature distribution at the air outlet 16. The wings 82 do not extend along a full length of the rib 80, and are tapered, with a greater width in an upper peripheral region of the second open end 76 of the heater housing 30. A first end 88 of the rib 80 is linear, with the wings 82 stopping before the first end 88.

The baffle 84 is generally wedge shaped in form, and extends orthogonally to, but in the same plane as, the rib 80. The baffle 84 and a second end 90 of the rib 80 define a slot for receiving a lower frontmost discrete mounting point 62 of the second portion 38 of the heater housing 30. The baffle 84 is located in a lower peripheral region of the second open end 76 of the heater housing 30. The baffle 84 inhibits airflow from exiting the lower peripheral region of the second open end 76 of the heater housing 30, and forces airflow from the lower peripheral region of the second open end 76 of the heater housing to mix with warmer airflow from the central region of the second open end 76 of the heater housing 30.

As noted above, it has been found that, due to the curvature of the outer body 12, the heater 28 and the heater housing 32, along with swirl downstream of the airflow generator 18, a relatively fast and cold airflow may be experienced in a peripheral region of the heater housing 30. This may be mitigated by providing the baffle 84, which may provide a relatively even temperature distribution at the air outlet 16.

As seen in FIG. 7, frontmost upper and lower discrete mounting points 50 of the first portion 36 of the heater housing 30 and discrete mounting points 62 of the second portion 38 of the heater housing 30 extend forwardly of the main body 32 of the heater 28. The rib 82 of the flow guide 78 is located between the frontmost upper and lower discrete mounting points 50 of the first portion 36 of the heater housing 30 and discrete mounting points 62 of the second portion 38 of the heater housing 30, and is welded to the discrete mounting points 50,62. The frontmost upper and lower discrete mounting points 50 of the first portion 36 of the heater housing 30 and discrete mounting points 62 of the second portion 38 of the heater housing 30 have a depth greater than a depth of the rib 82 of the flow guide 78, which enables the flow guide 78 to be fitted in direct thermal contact with the main body 32 of the heater 28 even where dimensions of the main body 32 of the heater 28 vary due to tolerances in manufacture.

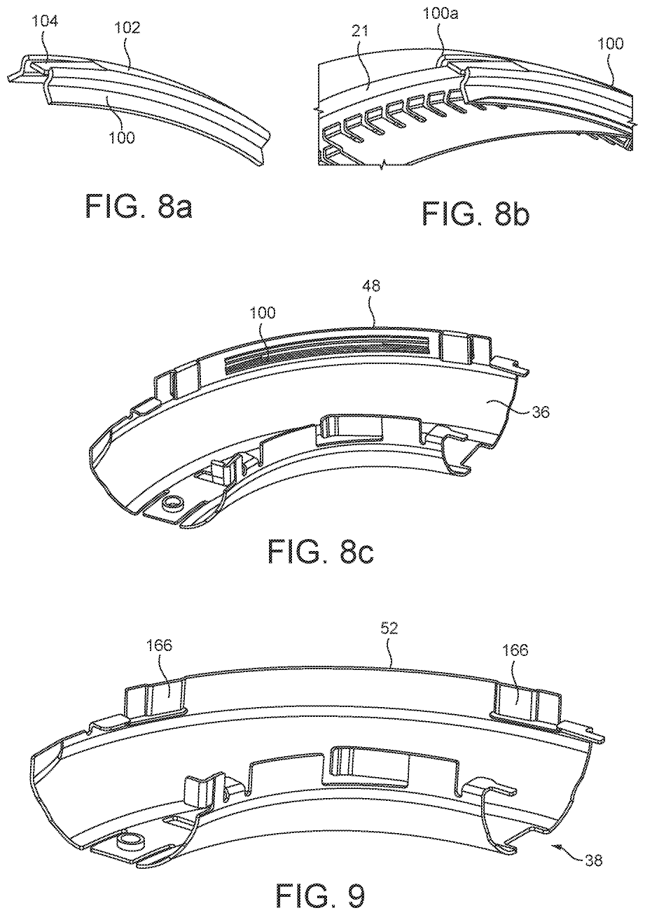

FIGS. 8a, 8b and 8c show a reinforcing rib 100 which can be connected to an outer edge of the curve of the heater main body 32 of the top surface 21. It will be appreciated that the outer curve of the heater 28 is significantly longer than an inner curve of the heater 28 making the distance between discrete mounting points 50 greater. To combat any additional stresses on the heater main body 28, the reinforcing rib can be applied. The reinforcing rib extends along a length of the heater 28 between the discrete mounting portions 50 that extend at the top 40 of the first portion 36 of the heater mount. The reinforcing rib 100 is V or U shaped and adapted to receive the heater main body 32 within its' internal space. When the heater housing is assembled, a top surface 102 of the reinforcing rib 100 abuts the mating surface 48 of the first portion 36 of the heater housing and is laser welded thereto, providing a fifth mounting region for the heater main body 32 with respect to the heater housing 30. Such a reinforcing rib 100 may mitigate any bending of the heater main body 32 during an impact. An upstream end 100a of the reinforcing body 100 is provided with a resilient mounting member 104 which engages with the top surface 21 of the heater main body 32. This allows for tolerance is the size of the heater main body 32 and provides a damping effect in the event of the appliance being dropped.

1. A haircare appliance comprising an air inlet, an air outlet, an airflow generator for generating an airflow from the air inlet to the air outlet, and a heater assembly for heating the airflow, the heater assembly comprising a heater and a heater housing, wherein the heater is mounted to the heater housing at a plurality of discrete mounting points.

2. The haircare appliance as claimed in claim 1, wherein the haircare appliance comprises a mounting member located at at least one of the plurality of discrete mounting points, and the mounting member is resiliently deformable.

3. The haircare appliance as claimed in claim 2, wherein the mounting member comprises a discrete mounting member attached to the heater housing.

4. The haircare appliance as claimed in claim 3, wherein the mounting member comprises a first material, the heater housing comprises a second material, and the first material is relatively softer than the second material.

5. The haircare appliance as claimed in claim 4, wherein the first material comprises any of copper or nickel, and the second material comprises stainless steel.

6. The haircare appliance as claimed in claim 2, wherein the mounting member is integrally formed with the heater housing.

7. The haircare appliance as claimed in claim 2, wherein the mounting member comprises a fixed mounting member that defines at least one of the plurality of discrete mounting points.

8. The haircare appliance as claimed in claim 7, wherein the fixed mounting member inhibits motion of the heater in a first direction, and the resiliently deformable member inhibits motion of the heater in a second direction different to the first direction.

9. The haircare appliance as claimed in claim 1, wherein the heater housing comprises first and second portions attached to one another.

10. The haircare appliance as claimed in claim 9, wherein the first and second portions are welded to one another.

11. The haircare appliance as claimed in claim 9, where the first and second portions are attached to one another such that the first and second portions overlap.

12. The haircare appliance as claimed in claim 1, wherein the heater and the heater housing are curved in form.

13. The haircare appliance as claimed in claim 1, wherein the heater comprises a main body, and a plurality of fins extending outwardly from the main body, and the main body is mounted to the heater housing at the plurality of discrete mounting points.

14. The haircare appliance as claimed in claim 1, wherein the heater comprises a ceramic material.

15. The haircare appliance as claimed in claim 1, wherein the heater housing comprises a first open end in fluid communication with the air inlet, and a second open end in fluid communication with the air outlet, and the haircare appliance comprises a flow guide for guiding airflow exiting the second open end.

16. The haircare appliance as claimed in claim 15, wherein the flow guide is shaped to direct airflow exiting a central region of the second open end in a direction away from the central region.

17. The haircare appliance as claimed in claim 15, wherein the flow guide is shaped to inhibit airflow exiting a peripheral region of the second open end.

18. A heater assembly for heating airflow through a haircare appliance, the heater assembly comprising a heater and a heater housing, wherein the heater is mounted in the heater housing at a plurality of discrete mounting points.
